(19) United States
(12) Patent Application Publication
(10) Pub. No.: US 2003/0026973 A1
(43) Pub. Date: Feb. 6, 2003

(54) Micro-porous granulate structures made of polypropylene comprising phase change material

(76) Inventor: Barbara Hildegard Pause, Longmont, CO (US)

Correspondence Address: Barbara H. Pause, 7161 Christopher Court, Longmont, CO, 80503, US

(21) Appl. No.: 10/190,463

(22) Filed: Jul. 5, 2002

Related U.S. Application Data
(60) Provisional application No. 60/304,635, filed on Jul. 11, 2001.

(51) Int. Cl. B32B 3/26; B32B 5/14; B32B 5/16; B32B 9/00; B32B 9/02; B32B 9/04

(52) U.S. Cl. 428/310.5; 428/304.4; 428/402.2

(57) ABSTRACT

The technique of the present invention includes a plurality of micro-porous granulate structures made of polypropylene comprising phase change material. The micro-porous polypropylene granulate structure absorbs and holds about 60% to 75% of a phase change material. The micro-porous polypropylene granulate structures with incorporated phase change material are free flowing, conformable powders or pellets possessing particle sizes between 0.01 millimeter and 1.0 millimeter. The phase change materials incorporated in the micro-porous polypropylene granulate structures are alkyl hydrocarbons, salt hydrates, poly-alcohols, or eutectics with melting and freezing temperatures between −10° C. and 150° C. In order to manufacture the micro-porous polypropylene granulates comprising phase change material the granulate is stirred into the liquefied phase change material. The liquefied phase change material is soaked into the micron-size voids of the granulate by capillary absorption with support of a vacuum. Finally, a secondary heating process is applied in order to remove surplus phase change material sticking to the granulate surface. The micro-porous polypropylene powder with incorporated phase change material can be coated or glued onto the surface of a textile or other material. The pellets can be filled into a three-dimensional textile structure, an elastomeric polymer, a visco-elastic fluid or a composite of granulate structures. The pellets can also be extruded to form a film or a sheet-like structure. In each case, the heat storage capacity of a textile, a building product or any other material is enhanced substantially.

### CROSS-REFERENCES TO RELATED APPLICATIONS

U.S. Pat. No. 5,366,801, Nov. 22, 1994, Bryant et al.

U.S. Pat. No. 5,637,389, Jun. 10, 1997, Colvin et al.

### BACKGROUND OF THE INVENTION

Phase change material possesses the ability to change its physical state within a certain temperature range. A phase change from the solid state to the liquid state occurs when the phase change material is heated beyond its melting temperature point. During this melting process, the phase change material absorbs and stores a large amount of latent heat. The temperature of the phase change material remains nearly constant during the entire process. In a cooling process, the heat stored by the phase change material is released into the environment in a certain temperature range and a reverse phase change from the liquid state to the solid state takes place. During this crystallization process, the temperature of the phase change material also remains constant. The high heat transfer during the melting process and the crystallization process, both without any temperature change, is responsible for the phase change material's appeal as a source of heat storage.

In order to contrast the amount of latent heat absorbed by a phase change material during the actual phase change with the amount of sensible heat in an ordinary heating process, the ice-water phase change process will be used. When ice melts, it absorbs an amount of latent heat of about 335 J/g. When the water is further heated, it absorbs a sensible heat of only 4 J/g while its temperature rises by one degree C. Therefore, the latent heat absorption during the phase change from ice into water is nearly 100 times higher than the sensible heat absorption during the heating process of water outside the phase change temperature range.

In addition to ice (water), more than 500 natural and synthetic phase change materials are known, including alkyl hydrocarbons, salt hydrates, poly-alcohols, and eutectic. These materials differ from one another in their phase change temperature ranges and their heat storage capacities.

In the present applications of the phase change material technology in garments and home furnishing products, alkyl hydrocarbons with different chain lengths are used exclusively. Characteristics of applied alkyl hydrocarbons are summarized in Table 1.

TABLE 1
Thermal characteristics of selected alkyl hydrocarbons

| | Melting | Crystallization | Latent heat storage |
|---|---|---|---|
| Alkyl | temperature, | temperature, | capacity, |
| hydrocarbon | ° C. | ° C. | J/g |
| Heneicosane | 40.5 | 35.9 | 213 |
| Eicosane | 36.1 | 30.6 | 247 |
| Nonadecane | 32.1 | 26.4 | 222 |
| Octadecane | 28.2 | 25.4 | 244 |

Compared to other phase change materials, the alkyl hydrocarbons possess very high heat storage capacities. Furthermore, alkyl hydrocarbons can be mixed in order to realize desired temperature ranges in which the phase change will take place. Alkyl hydrocarbons are nontoxic, non-corrosive and non-hygroscopic. The thermal behavior of the alkyl hydrocarbons remains stable also under permanent use. Alkyl hydrocarbons are byproducts of petroleum refining and therefore inexpensive. A disadvantage of the alkyl hydrocarbons is their low resistance to ignition. But this problem can be solved by adding fire retardants.

In order to prevent a dissolution of the alkyl hydrocarbons (while in its liquid phase), the alkyl hydrocarbons are encapsulated in microcapsules with diameters of only a few microns before they will be applied to a textile structure used in the garments or home furnishing products. The microcapsules with the enclosed alkyl hydrocarbon are applied to a textile matrix by incorporating them into foams or by coating them onto a textile surface. For example, microencapsulated phase change materials, such as alkyl hydrocarbons, have been described as a suitable component for substrate coating when exceptional heat storage capabilities are desired. The U.S. Pat. No. 5,366,801 for “Fabrics with reversible enhanced thermal properties” to Bryant, et al., incorporated herein by reference, states that substrates coated with a binder containing microencapsulated phase change material, such as alkyl hydrocarbons, enables a substrate to exhibit extended heat storage properties. Furthermore, microencapsulated phase change materials such as alkyl hydrocarbons have been described as a suitable component for inclusion in foams. U.S. Pat. No. 5,637,389 for “Thermally enhanced foam insulation” to Colvin et al., also incorporated herein by reference, reports a thermally enhanced foam insulation where the microcapsules with the incorporated phase change material such as alkyl hydrocarbon are embedded within the foam.

The micro-encapsulation process of crystalline alkyl hydrocarbons is a very time-consuming and complicated chemical process requiring several stages making the PCM-microcapsules very expensive. Such microcapsules are made, for instance, by dispersing droplets of the molten alkyl hydrocarbon in an aqueous solution of melamine formaldehyde pre-condensate and several additives such as urea formaldehyde and acryl amide or an acrylic acid copolymer. A polymerisation technique is widely used to form the walls around the alkyl hydrocarbon droplets. After preparing the aqueous solution of the chemicals that make up the microcapsule wall the alkyl hydrocarbon are dispersed into the solution. The dispersion is then stirred for a period of about half an hour. After the formation of a stable dispersion, the temperature of the reaction medium is raised up to about 55° C. in order to accelerate the condensation reaction and thus, the microcapsule wall formation. The heating process normally lasts for about two hours. The dispersion is then allowed to cool and is left stirring overnight, after which usable capsules are found to be present. As a result of formaldehyde included in the pre-condensate, formaldehyde fumes may evolve from the capsule dispersion which are being removed by adding an ammonium compound or other materials consuming the formaldehyde. Only alkyl hydrocarbons with melting temperatures below 55° C. can be microencapsulated. The described micro-encapsulation technology is also not useful for salt hydrates, poly-alcohols and eutectics.

### SUMMARY OF THE INVENTION

The invention pertains to micro-porous granulate structure consisting of polypropylene powder or pellets which is used to absorb and contain phase change materials such as crystalline alkyl hydrocarbons. The formed macro-particles have sizes between 0.01 mm and 2 mm. The porous structure of these polypropylene powder or pellets allows for a loading capacity of the phase change material of about 60% to 75%. In order to manufacture the micro-porous polypropylene granulates comprising phase change material, the granulate is stirred into the liquefied phase change material. The liquefied phase change material is soaked into the micron-size voids of the granulate by capillary absorption with the support of a vacuum. Finally, a secondary heating process is applied in order to remove surplus phase change material sticking to the granulate surface.

Aside from alkyl hydrocarbons, other phase change materials such as salt hydrates, poly-alcohols, or eutectics with melting and freezing temperatures between −10° C. and 150° C. can be incorporated into the micro-porous polypropylene granulate structures.

The micro-porous polypropylene powder with incorporated phase change material can be coated or glued onto the surface of a fabric or any other material. The micro-porous polypropylene pellets can be filled into a three-dimensional textile structure, an elastomeric polymer, a visco-elastic fluid or a composite of granulate structures. The pellets can also be extruded to form a film or a sheet-lie polymer structure. In each case, the heat storage capacity of a textile, a building product or any other material is enhanced substantially.

### DETAILED DESCRIPTION OF THE INVENTION

The applicant has discovered that phase change material such as alkyl hydrocarbons can be soaked into micro-porous granulates. This micro-porous granulates are made from polymeric resins. Some common resins such as polypropylene, polyamide and polyethylene are available in micro-porous form. However, applicant has figured out that micro-porous granulates made of polypropylene are the most favourable structures for containing alkyl hydrocarbons and other phase change materials.

Compared to the micro-encapsulation process, the macro-encapsulation process, which the invention is based on, is performed in a relatively simple manner and takes only a short period of time. There are no restrictions regarding the melting temperature of the phase change material and there is no need to remove chemical parts or fumes after the process is complete.

Then macro-encapsulating crystalline alkyl hydrocarbons they need to be melted first until they are liquefied completely. Then, the liquid alkyl hydrocarbons are mixed into the micro-porous granulate and soaked in the micron-size voids of the polymer by capillary absorption. The mixing is done at or slightly above room temperature. A vacuum is supplied to the system in order to ensure a complete absorption of the alkyl hydrocarbons. Strong adhesion forces, due to the large inner surface of the micro-porous cell structure create a complete and durable containment of the alkyl hydrocarbons inside the micro-porous granulate structure possible. In order to ensure that no alkyl hydrocarbon are bonded to the surface of the micro-porous granulate structure, the system undergoes a secondary heating process in which the surplus alkyl hydrocarbon sticking to the granulate surface is removed. At the end of the manufacturing process micro-porous polypropylene granulate structure is available as a free flowing, conformable powder or pellets.

The structure of these micro-porous polypropylene granulate allows for a loading capacity of up to 75%. In reference to the volume extension of the alkyl hydrocarbons of about 10% in the liquid stage, a loading capacity between 60% and 65% has been applied. The formed macro-capsules have sizes between 0.01 millimeter and 1 millimeter. The inner surface area of the cells is about 80 m²/g to 90 m²/g. The density of the micro-porous polypropylene granulate ranges from 100 kg/m³ to 300 kg/m². In contrast, the alkyl hydrocarbons possess densities of about 800 kg/m³. Encapsulating about 65% of alkyl hydrocarbons increases the overall weight of the granulate cells by two to five times.

The polypropylene granulate is thermally stable in a temperature range between −20° C. and 160° C. Thermal tests of the polypropylene granulate with incorporated alkyl hydrocarbons have shown that the alkyl hydrocarbons do not disappear while in a liquid stage above their melting temperature due to the strong adhesion forces acting inside the cells. Polypropylene granulates possess moisture barrier properties. Therefore the systems can always be kept in a dry stage. The granulates swell slightly in size during the absorption of the alkyl hydrocarbons. However, after the absorption process is complete the micro-porous polypropylene granulates are mechanically stable. The micro-porous polypropylene granulates possess an appropriate thermal conductivity which ensures a sufficient heat transfer to and from the phase change material. Compared to other polymers, polypropylene already absorbs a substantial amount of sensible heat.

The alkyl hydrocarbons incorporated in the micro-porous granulate structure possess freezing and melting points in the temperature range between −10° C. and 150° C. Single alkyl hydrocarbons as well as mixtures whereof can be absorbed by the micro-porous polypropylene granulate structure. Beside alkyl hydrocarbons, the micro-porous polypropylene granulate structure may also be used to encapsulate salt hydrates, poly-alcohols, or eutectics operating in the same temperature range between −10° C. and 150° C. The free flowing property of micro-porous polypropylene powder is remained both above and below the melting temperature of the incorporated phase change materials.

The micro-porous polypropylene powder with incorporated alkyl hydrocarbon or other phase change materials such as salt hydrates, poly-alcohols, or eutectics can be coated or glued onto the surface of textiles or other materials The pellets can be filled into a three-dimensional textile structure, an elastomeric polymer, a visco-elastic fluid or a composite of granulate structures. The pellets can also be extruded to form a film or a sheet-like structure. In each case, the heat storage capacity of textiles, building products or any other materials is enhanced substantially. The micro-porous polypropylene granulate structure comprising phase change material can be used in garments, medical products, building systems, containers and sun protection products.

What is claimed is:

1. A composition consisting of a plurality of micro-porous granulate structures made of polypropylene comprising phase change material having particle sizes between 0.01 millimeter and 1.0 millimeter.

2. A composition according to claim 1, wherein said composition is made by mixing the liquefied phase change material into the micro-porous granulate, soaking the liquefied phase change material into the micron-size voids of the polymer by capillary absorption with support of a vacuum and finally applying a secondary heating process in order to remove surplus phase change material sticking to the granulate surface.

3. A composition according to claim 1, wherein said composition is in the form of a freely flowing powder-like structure.

4. A composition according to claim 1, wherein said composition consists of a plurality of a pellet-like structure.

5. A composition according to claim 1, wherein said composition is mechanically stable, moisture resistant and possess an appropriate thermal conductivity which ensures a sufficient heat transfer to and from the phase change material.

6. A composition according to claim 1, wherein said phase change material has melting and freezing points between −10° C. and 150° C.

7. A composition according to claim 1, wherein said phase change material is present in an amount of 60% to 75%.

8. A composition according to claim 1, wherein said phase change material consists an alkyl hydrocarbon, mixtures of more than one alkyl hydrocarbons, a salt hydrate, a poly-alcohol, or an eutectic material.

9. A composition according to claim 1, wherein said the powder-like micro-porous polypropylene granulate is coated or glued onto the surface of a textile or other material.

10. A composition according to claim 1, wherein said the pellet-like micro-porous polypropylene granulate structures are filled into a three-dimensional textile structure, an elastomeric polymer, a visco-elastic fluid or a composite of granulate structures.

11. A composition according to claim 1, wherein said the pellet-like micro-porous polypropylene granulate structures are extruded to form a film or a sheet-like structure.
